(19) United States
(12) Patent Application Publication
(10) Pub. No.: US 2026/0106099 A1
(43) Pub. Date: Apr. 16, 2026

(54) CONTACTOR MAGNETIC CORE, CONTACTOR ELECTROMAGNETIC ASSEMBLY AND CONTACTOR

(71) Applicants: Tyco Electronics (Shanghai) Co., Ltd., Shanghai (CN); Tyco Electronics Technology (SIP) Co., Ltd., Suzhou (CN)

(72) Inventors: Zesheng Jiang, Suzhou (CN); Kevin (Xujia) Wang, Suzhou (CN); Quarry (Bingfeng) Qu, Suzhou (CN); Wenpei Qin, Suzhou (CN); Lizhong Wang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/354,939

(22) Filed: Oct. 10, 2025

(30) Foreign Application Priority Data
Oct. 11, 2024 (CN) 202411416357.8

(51) Int. Cl. H01H 50/04; H01H 50/36; H01H 50/44; H01H 50/60

(52) U.S. Cl. CPC H01H 50/045; H01H 50/36; H01H 50/443; H01H 50/60

(57) ABSTRACT

A contactor magnetic core includes a static magnetic core fixable to a magnetic plate of a contactor and having a main body insertable into a coil skeleton of the contactor, and a movable magnetic core insertable into the coil skeleton in a movable manner and having a flange at an upper end. When the static magnetic core and the movable magnetic core are inserted into the coil skeleton, the main body of the static magnetic core faces the flange of the movable magnetic core. A diameter of the main body of the static magnetic core is larger than a diameter of the flange of the movable magnetic core to increase an electromagnetic attraction between the static magnetic core and the movable magnetic core.

### CROSS-REFERENCE TO RELATED APPLICATION

This application claims the benefit of the filing date under 35 U.S.C. § 119(a)-(d) of Chinese Patent Application No. 202411416357.8, filed on Oct. 11, 2024.

### FIELD OF THE INVENTION

The present invention relates to a contactor magnetic core, a contactor electromagnetic assembly comprising the contactor magnetic core, and a contactor comprising the contactor electromagnetic assembly.

### BACKGROUND OF THE INVENTION

A contactor electromagnetic assembly typically includes a U-shaped magnetic yoke, a magnetic plate installed on the top opening of the U-shaped magnetic yoke, a coil assembly set in the magnetic yoke, and a magnetic core set in the coil skeleton of the coil assembly. The magnetic core includes a static magnetic core and a movable magnetic core. The static magnetic core is fixed to the magnetic plate and its main body is inserted into the coil skeleton. The movable magnetic core is inserted into the coil skeleton in a movable manner, and can be moved relative to the static magnetic core between the working position in axial contact with the static magnetic core and the initial position separated from the static magnetic core in the axial direction.

The main body of the static magnetic core and the movable magnetic core are usually cylindrical without steps, with the same diameter and the same magnetic conducting area, which results in a smaller electromagnetic attraction between the static magnetic core and the movable magnetic core. In order to increase the electromagnetic attraction between the static magnetic core and the movable magnetic core, it is necessary to increase the number of turns of the contactor coil, which not only increases the amount of copper used in the coil, increasing costs, but also increases the volume.

### SUMMARY OF THE INVENTION

A contactor magnetic core includes a static magnetic core fixable to a magnetic plate of a contactor and having a main body insertable into a coil skeleton of the contactor, and a movable magnetic core insertable into the coil skeleton in a movable manner and having a flange at an upper end. When the static magnetic core and the movable magnetic core are inserted into the coil skeleton, the main body of the static magnetic core faces the flange of the movable magnetic core. A diameter of the main body of the static magnetic core is larger than a diameter of the flange of the movable magnetic core to increase an electromagnetic attraction between the static magnetic core and the movable magnetic core.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a contactor electromagnetic assembly according to an exemplary embodiment of the present invention;

FIG. 2 shows an axial sectional view of a contactor electromagnetic assembly according to an exemplary embodiment of the present invention;

FIG. 3 shows an illustrative exploded view of a contactor electromagnetic assembly according to an exemplary embodiment of the present invention;

FIG. 4 shows a plan sectional view of a contactor electromagnetic assembly according to an exemplary embodiment of the present invention, wherein the movable magnetic core is in an initial position axially separated from the static magnetic core;

FIG. 5 shows a plan sectional view of a contactor electromagnetic assembly according to an exemplary embodiment of the present invention, in which the movable magnetic core is in a working position in axial contact with the static magnetic core, and the drive shaft is shown;

FIG. 6 shows an illustrative view of the movable and static magnetic cores of a contactor electromagnetic assembly according to an exemplary embodiment;

FIG. 7 shows an illustrative perspective view of the terminals and coils of a contactor electromagnetic assembly according to an exemplary embodiment of the present invention;

FIG. 8 shows an illustrative perspective view of the terminal module and coil of a contactor electromagnetic assembly according to an exemplary embodiment;

FIG. 9 shows an illustrative perspective view of the coil assembly of a contactor electromagnetic assembly according to an exemplary embodiment of the present invention;

FIG. 10 shows a plan sectional view of a contactor electromagnetic assembly according to another exemplary embodiment; and

FIG. 11 shows an illustrative view of the movable and static magnetic cores of a contactor electromagnetic assembly according to another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

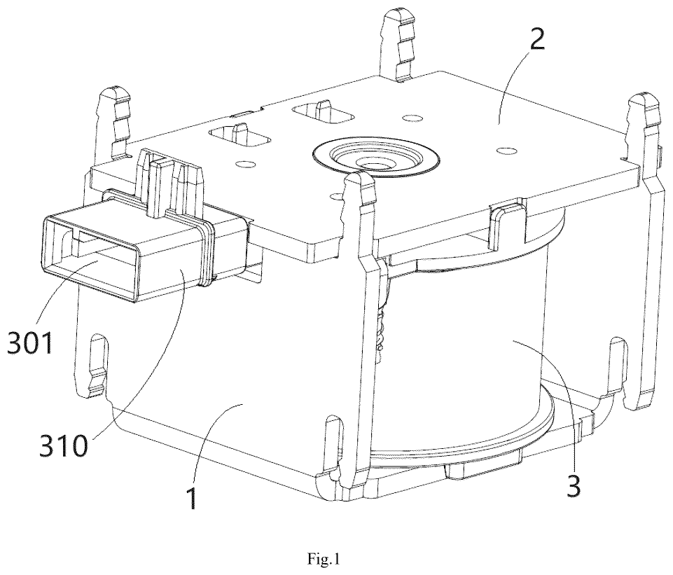

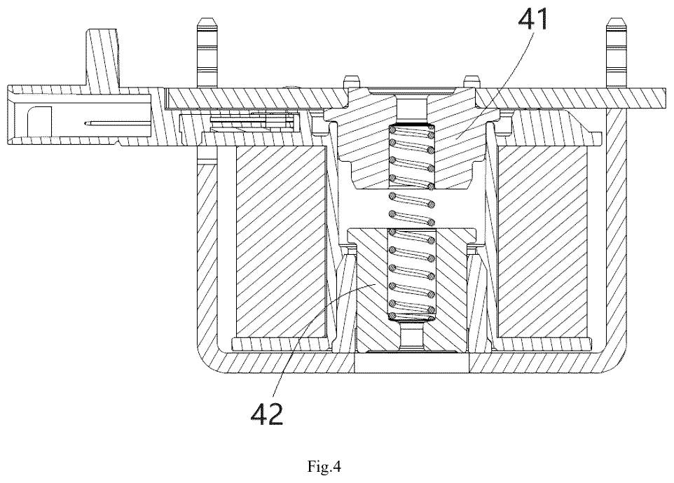

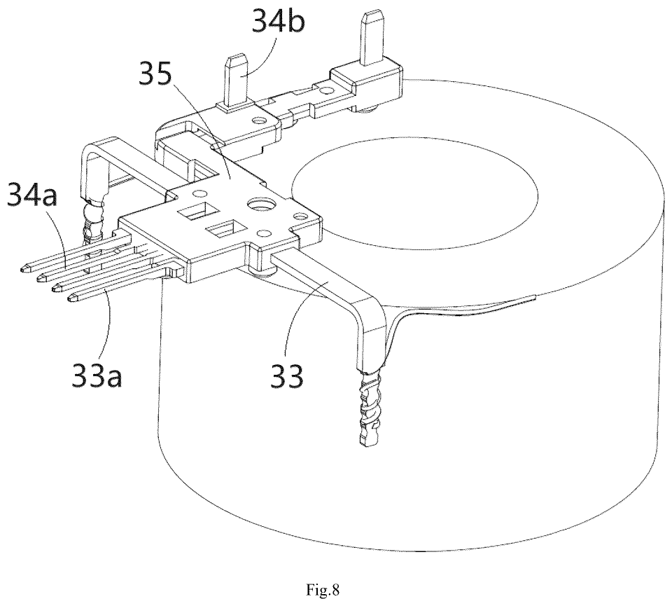

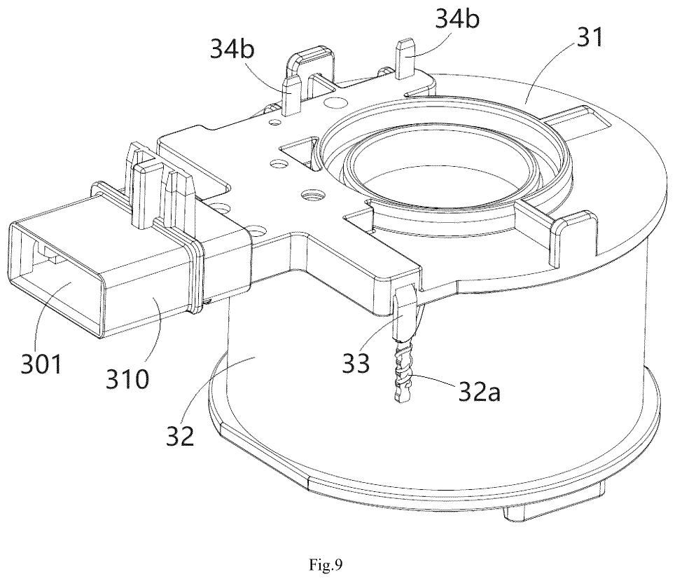

As shown in FIGS. 1 to 9, in an exemplary embodiment of the present invention, a contactor magnetic core is disclosed. The contactor magnetic core includes a static magnetic core 41 and a movable magnetic core 42. The static magnetic core 41 is suitable for being fixed to the magnetic plate 2 of the contactor and has a main body 410 suitable for being inserted into a coil skeleton 31 of the contactor. The movable magnetic core 42 is suitable for being inserted into the coil skeleton 31 in a movable manner and has a flange 42a located at its upper end. In the illustrated embodiment, when the static magnetic core 41 and the movable magnetic core 42 are inserted into the coil skeleton 31, the main body 410 of the static magnetic core 41 faces the flange 42a of the movable magnetic core 42, and the diameter of the main body 410 of the static magnetic core 41 is slightly larger than the diameter of the flange 42a of the movable magnetic core 42, in order to increase the electromagnetic attraction between the static magnetic core 41 and the movable magnetic core 42. For example, the electromagnetic attraction of the contactor can be increased when in the holding state and initial state.

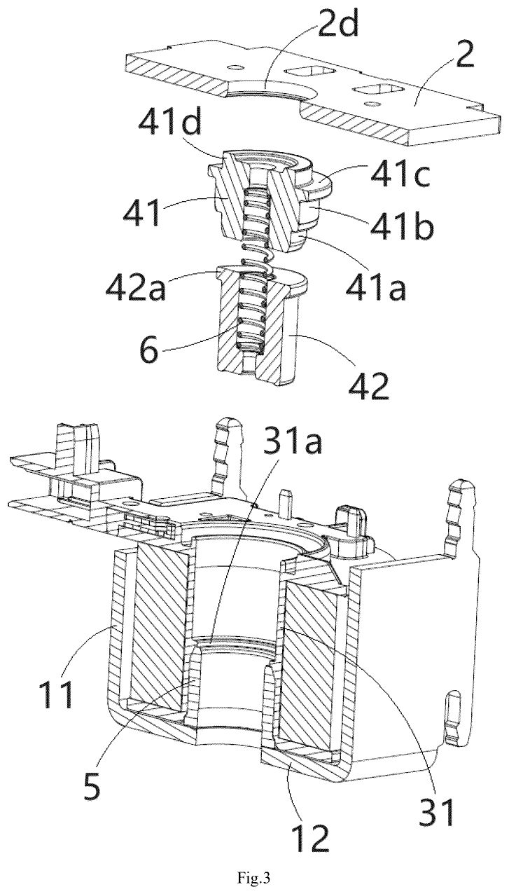

As shown in FIG. 3, in the illustrated embodiment, the main body 410 of the static magnetic core 41 has a first cylindrical portion 41a located at its lower end and a second cylindrical portion 41b located at its upper end. The first cylindrical portion 41a and the second cylindrical portion 41b are coaxially connected, and the diameter of the first cylindrical portion 41a is smaller than that of the second cylindrical portion 41b, so that the main body 410 of the static magnetic core 41 has a stepped shaft shape with different diameters. In the illustrated embodiment, the diameter of the first cylindrical portion 41a of the static magnetic core 41 is equal to or slightly smaller than the diameter of the flange 42a of the movable magnetic core 42, and the diameter of the second cylindrical portion 41b of the static magnetic core 41 is slightly larger than the diameter of the flange 42a of the movable magnetic core 42.

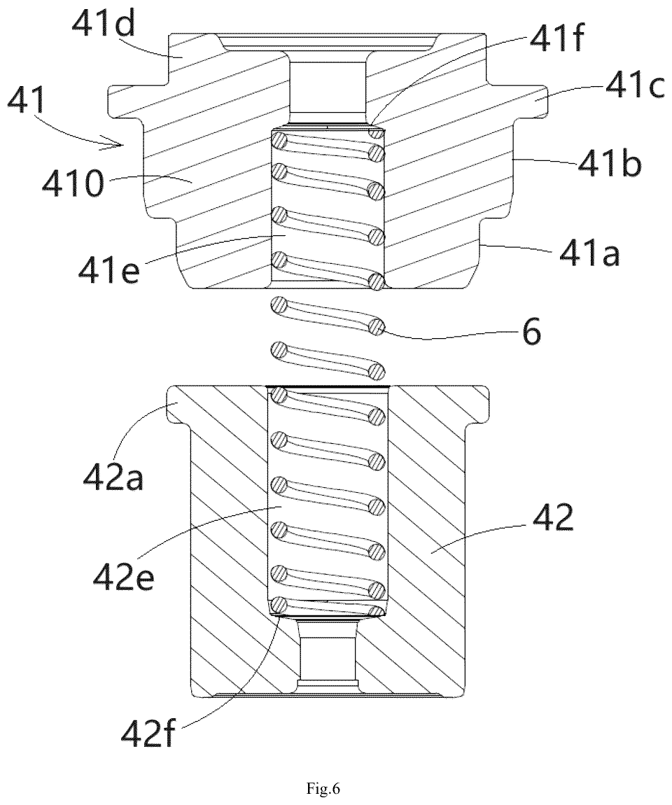

As shown in FIG. 6, in the illustrated embodiment, a first central through-hole 41e is formed in the static magnetic core 41, and a first positioning step 41f is formed in the first central through-hole 41e. The first positioning step 41f is used to axially press against the upper end of the reset spring 6 of the contactor. A second central through-hole 42e is formed in the movable magnetic core 42, and a second positioning step 42f is formed in the second central through-hole 42e, which is used to axially rest on the lower end of the reset spring 6.

As shown in FIGS. 3 and 6, in the illustrated embodiment, the static magnetic core 41 also has a positioning flange portion 41c formed on the outer side of the upper end of its main body 410, and the positioning flange portion 41c is adapted to rest against the bottom surface of the magnetic plate 2. In the illustrated embodiment, the static magnetic core 41 also has a fixing portion 41d coaxially connected to the upper end of its main body 410. The fixing portion 41d of the static magnetic core 41 is used to be fixed into the fixing hole 2d in the magnetic plate 2. The fixing portion 41d of the static magnetic core 41 is suitable for being inserted into the fixing hole 2d of the magnetic plate 2 in an interference fit manner or for being riveted into the fixing hole 2d of the magnetic plate 2.

In another exemplary embodiment of the present invention, a contactor electromagnetic assembly is also disclosed. The contactor electromagnetic assembly includes, as shown in FIGS. 1 to 3, a magnetic yoke 1, a magnetic plate 2, a coil assembly 3, and a contactor magnetic core. The magnetic yoke 1 is U-shaped. The magnetic plate 2 is installed on the top opening of magnetic yoke 1. The coil assembly 3 is set in the magnetic yoke 1 and includes a coil skeleton 31 and a coil 32 wound around the coil skeleton 31. The static magnetic core 41 is fixed to the magnetic plate 2 and its main body 410 is inserted into the coil skeleton 31, while the movable magnetic core 42 is inserted into the coil skeleton 31 in a movable manner.

The movable magnetic core 42 can be moved between a working position in axial contact with the static magnetic core 41 and an initial position in axial separation from the static magnetic core 41. When the coil 32 is energized, the movable magnetic core 42 is moved from its initial position to its working position under the action of electromagnetic force.

As shown in FIGS. 3 and 6, in the illustrated embodiment, the contactor electromagnetic assembly further includes a reset spring 6, which is axially compressed between the static magnetic core 41 and the movable magnetic core 42 to apply an elastic reset force to the movable magnetic core 42. When the coil 32 loses power, the movable magnetic core 42 is moved from the working position to the initial position under the action of the reset spring 6.

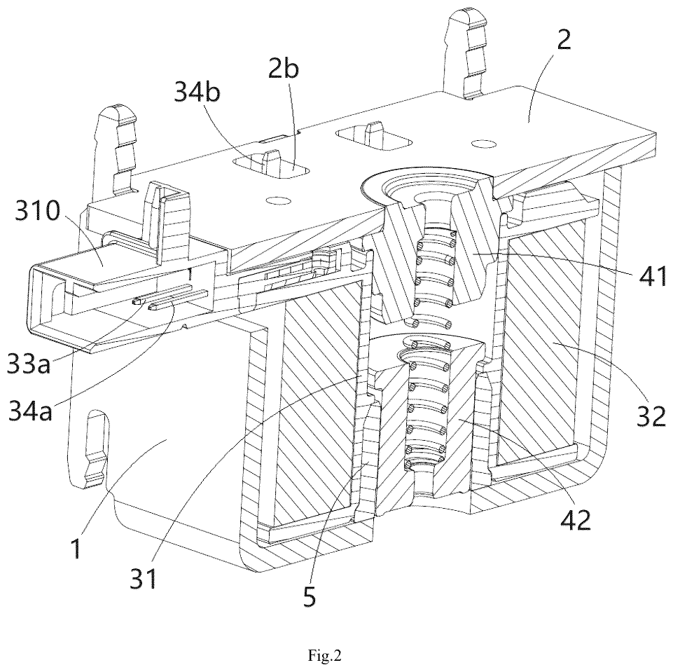

As shown in FIGS. 2 to 4, in the illustrated embodiment, a limit step 31a is formed in the coil skeleton 31, which is used to axially abut against the flange 42a of the movable magnetic core 42 to restrict the movable magnetic core 42 in its initial position.

As shown in FIG. 6, in the illustrated embodiment, a first central through-hole 41e is formed in the static magnetic core 41 and a first positioning step 41f is formed in the first central through-hole 41e, and a second central through-hole 42e is formed in the movable magnetic core 42 and a second positioning step 42f is formed in the second central through-hole 42e. The upper end of the reset spring 6 is accommodated in the first central through-hole 41e and axially rests against the first positioning step 41f, and the lower end of the reset spring 6 is accommodated in the second central through-hole 42e and axially rests against the second positioning step 42f.

As shown in FIG. 3, in the illustrated embodiment, a fixing hole 2d is formed in the magnetic plate 2, and the fixing portion 41d of the static magnetic core 41 is fixed into the fixing hole 2d of the magnetic plate 2.

As shown in FIG. 3, in the illustrated embodiment, the contactor electromagnetic assembly further includes a magnetic sleeve 5, which is inserted into the lower end of the coil skeleton 31. The movable magnetic core 42 is arranged in the magnetic sleeve 5 so that it can be moved axially relative to the magnetic sleeve 5.

As shown in FIG. 3, in the illustrated embodiment, the magnetic yoke 1 includes a pair of side plates 11 and a bottom plate 12 located between the pair of side plates 11. The lower end of the magnetic sleeve 5 is pressed against the bottom plate 12 of the magnetic yoke 1, and the upper end of the magnetic sleeve 5 is pressed against the limit step 31a inside the coil skeleton 31, so that the magnetic sleeve 5 cannot be moved axially.

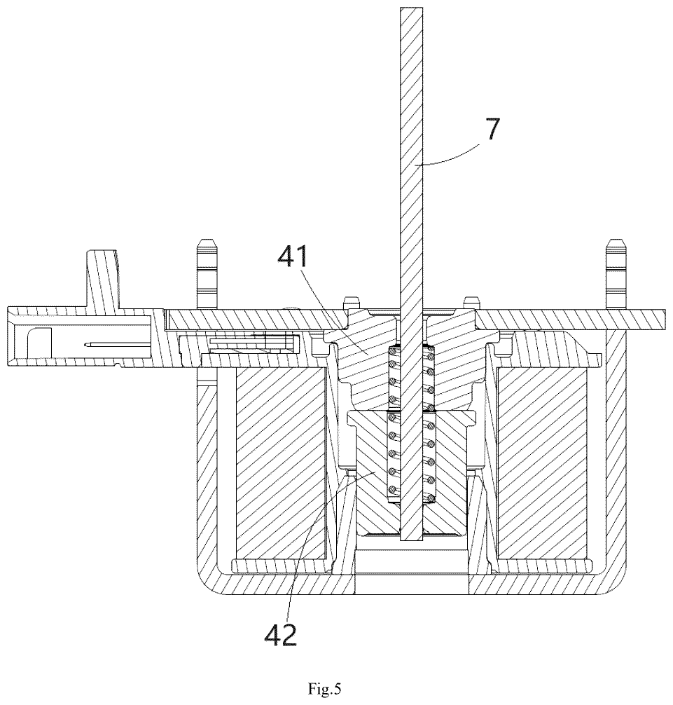

As shown in FIG. 5, in the illustrated embodiment, the contactor electromagnetic assembly further comprises a drive shaft 7, which passes axially through the static magnetic core 41 and the movable magnetic core 42, for driving the movable contact of the contactor to move between an open position electrically separated from the static contact and a closed position electrically in contact with the static contact. The lower end of drive shaft 7 is welded to the movable magnetic core 42 and can be moved axially relative to the static magnetic core 41.

When the movable magnetic core 42 is moved to the working position, the drive shaft 7 drives the movable contact to the closed position. When the movable magnetic core 42 is moved to the initial position, the drive shaft 7 drives the movable contact to the open position.

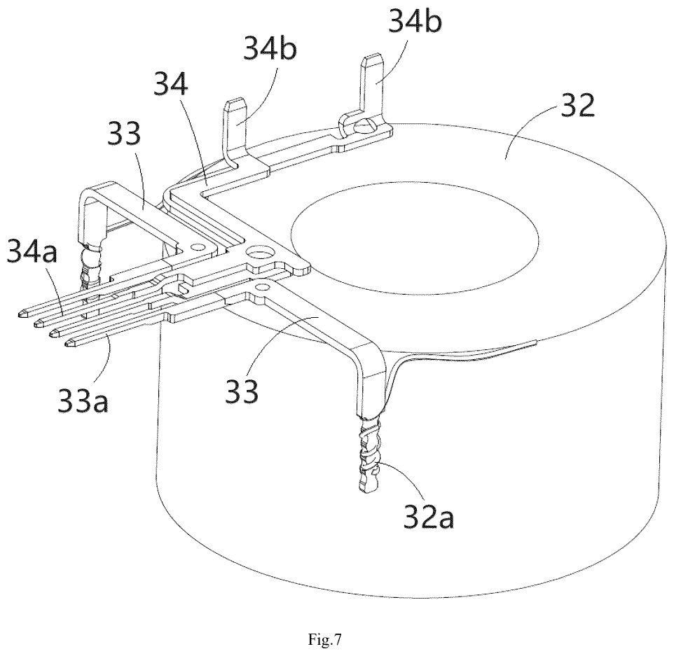

The coil assembly 3 also includes a terminal module. The terminal module includes a pair of coil terminals 33, a pair of signal terminals 34, and a retaining body 35, shown in FIGS. 7 to 9. A pair of coil terminals 33 are respectively connected to the two terminal terminals 32 of coil 32. A pair of signal terminals 34 are used for electrical connection to auxiliary contacts of the contactor. The retaining body 35 is injection molded onto the pair of coil terminals 33 and the pair of signal terminals 34, making the retaining body 35, the pair of coil terminals 33, and the pair of signal terminals 34 an integrated piece. The coil skeleton 31 is injection molded onto the terminal module, making the coil skeleton 31 and the terminal module an integrated piece.

As shown in FIG. 7, in the illustrated embodiment, the signal terminal 34 has a mating end 34b suitable for mating with an auxiliary contact adapter terminal, and a slot hole 2b is formed in the magnetic plate 2, as shown in FIG. 2. The mating end 34b of the signal terminal 34 is exposed from the slot hole 2b of the magnetic plate 2 for mating with the auxiliary contact adapter terminal.

As shown in FIG. 2, in the illustrated embodiment, the coil skeleton 31 has a mating portion 310, which has an insertion slot 301 that allows a connector to be inserted. The coil terminal 33 has a first pin 33a, and the signal terminal 34 has a second pin 34a. The first pin 33a and the second pin 34a extend into the insertion slot 301 of the mating portion 310 to be electrically connected to the connector inserted into the insertion slot 301.

The electromagnetic suction force in the initial or holding state can be adjusted according to the application needs by using a first cylindrical portion 41b with a diameter different from that of the second cylindrical portion 41b. Within a certain range, the diameter of the first cylindrical portion 11a is positively correlated with the initial electromagnetic attraction, that is, the larger the diameter of the first cylindrical portion 11a, the greater the initial electromagnetic attraction. Within a certain range, the diameter of the first cylindrical portion 41b is inversely correlated with the electromagnetic suction force in the holding state, that is, the smaller the diameter of the first cylindrical portion 41b, the greater the electromagnetic suction force in the holding state.

In another exemplary embodiment of the present invention, a contactor is also disclosed. The contactor includes a housing, a pair of static contacts, a movable contact, and a contactor electromagnetic assembly. The housing is formed with an arc extinguishing chamber and a receiving chamber. A pair of static contacts are fixed to the housing and extend into the arc extinguishing chamber. The movable contact is set in the arc extinguishing chamber and can be moved between an open position electrically separated from the pair of static contacts and a closed position electrically in contact with the pair of static contacts. The contactor electromagnetic assembly is installed in the receiving chamber of the housing. The drive shaft 7 of the contactor electromagnetic assembly extends into the arc extinguishing chamber and is used to drive the movable contact to move between the open position and the closed position.

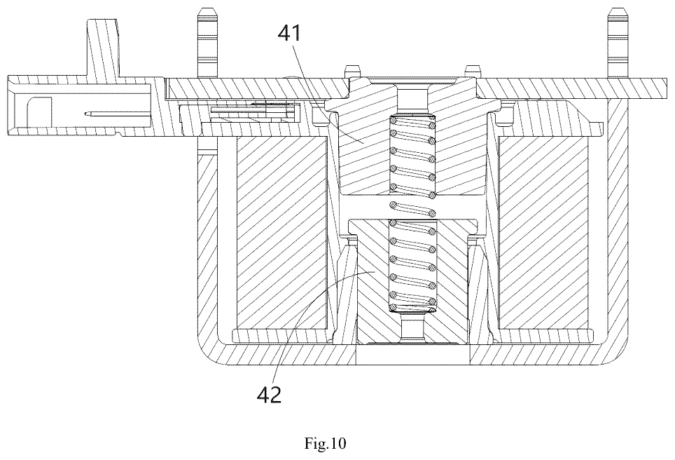

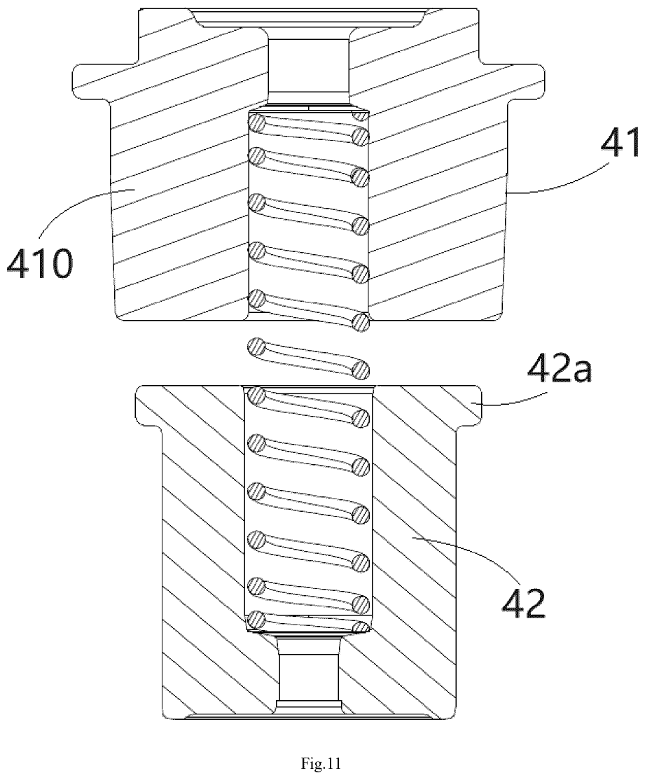

FIG. 10 shows a plan sectional view of a contactor electromagnetic assembly according to another exemplary embodiment of the present invention; FIG. 11 shows an illustrative view of the movable magnetic core 42 and the static magnetic core 41 of a contactor electromagnetic assembly according to another exemplary embodiment of the present invention.

The only difference between the contactor electromagnetic assembly shown in FIGS. 10 and 11 and those shown in FIGS. 1 to 9 is the structure of the static magnetic core. As shown in FIGS. 10 and 11, in the illustrated embodiment, the main body 410 of the static magnetic core 41 is in the shape of a shaft with a predetermined diameter, such that the outer peripheral surface of the main body 410 of the static magnetic core 41 is a cylindrical surface without steps. The diameter of the main body 410 of the static magnetic core 41 is slightly larger than the diameter of the flange 42a of the movable magnetic core 42. Except for the aforementioned differences, the other technical features of the contactor electromagnetic assembly shown in FIGS. 10 and 11 are basically the same as those of the contactor electromagnetic assembly shown in FIGS. 1 to 9, which can be referred to as the contactor electromagnetic assembly shown in FIGS. 1 to 9.

In the aforementioned exemplary embodiments according to the present invention, the diameter of the second cylindrical portion of the static magnetic core is slightly larger than the diameter of the flange of the movable magnetic core, so that the magnetic conductive area of the main body of the static magnetic core is larger than that of the static magnetic core, thereby effectively increasing the electromagnetic attraction between the static magnetic core and the movable magnetic core.

In the aforementioned exemplary embodiments according to the present invention, the electromagnetic suction force in the initial or holding state can be adjusted according to application needs by using a first cylindrical portion with a diameter different from that of the second cylindrical portion. Within a certain range, the diameter of the first cylindrical portion is positively correlated with the initial electromagnetic attraction, that is, the larger the diameter of the first cylindrical portion, the greater the initial electromagnetic attraction. Within a certain range, the diameter of the first cylindrical portion is inversely correlated with the holding state electromagnetic suction force, that is, the smaller the diameter of the first cylindrical portion, the greater the holding state electromagnetic suction force.

In addition, the present invention can reduce the number of turns and copper usage of the coil while ensuring sufficient electromagnetic attraction, thereby reducing the cost and volume of the contactor.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor magnetic core, comprising:
a static magnetic core fixable to a magnetic plate of a contactor and having a main body insertable into a coil skeleton of the contactor; and
a movable magnetic core insertable into the coil skeleton in a movable manner and having a flange at an upper end, when the static magnetic core and the movable magnetic core are inserted into the coil skeleton, the main body of the static magnetic core faces the flange of the movable magnetic core, a diameter of the main body of the static magnetic core is larger than a diameter of the flange of the movable magnetic core to increase an electromagnetic attraction between the static magnetic core and the movable magnetic core.

2. The contactor magnetic core according to claim 1, wherein the main body of the static magnetic core has a first cylindrical portion at a lower end and a second cylindrical portion at the upper end, the first cylindrical portion and the second cylindrical portion are coaxially connected, a diameter of the first cylindrical portion is smaller than a diameter of the second cylindrical portion, so that the main body of the static magnetic core has a stepped shaft shape with different diameters.

3. The contactor magnetic core according to claim 2, wherein the diameter of the first cylindrical portion of the static magnetic core is equal to or smaller than the diameter of the flange of the movable magnetic core, and the diameter of the second cylindrical portion of the static magnetic core is larger than the diameter of the flange of the movable magnetic core.

4. The contactor magnetic core according to claim 1, wherein the main body of the static magnetic core is a shaft with a predetermined diameter, an outer peripheral surface of the main body of the static magnetic core is a cylindrical surface without steps.

5. The contactor magnetic core according to claim 1, wherein a first central through-hole is formed in the static magnetic core, and a first positioning step is formed in the first central through-hole, the first positioning step axially rests on an upper end of a reset spring of the contactor, a second central through-hole is formed in the movable magnetic core, and a second positioning step is formed in the second central through-hole, the second positioning step axially rests on a lower end of the reset spring.

6. The contactor magnetic core according to claim 1, wherein the static magnetic core has a positioning flange portion formed on an outer side of an upper end of the main body, the positioning flange portion rests against a bottom surface of the magnetic plate.

7. The contactor magnetic core according to claim 1, wherein the static magnetic core also has a fixing portion coaxially connected to an upper end of the main body, the fixing portion of the static magnetic core is fixed into a fixing hole in the magnetic plate.

8. The contactor magnetic core according to claim 7, wherein the fixing portion of the static magnetic core is inserted into the fixing hole of the magnetic plate in an interference fit manner or is riveted into the fixing hole of the magnetic plate.

9. A contactor electromagnetic assembly, comprising:
a magnetic yoke that is U-shaped;
a magnetic plate installed on a top opening of the magnetic yoke;
a coil assembly installed in the magnetic yoke and including a coil skeleton and a coil wound around the coil skeleton; and
a contactor magnetic core, including:
a static magnetic core fixed to the magnetic plate and having a main body inserted into the coil skeleton; and
a movable magnetic core inserted into the coil skeleton in a movable manner and having a flange at an upper end, when the static magnetic core and the movable magnetic core are inserted into the coil skeleton, the main body of the static magnetic core faces the flange of the movable magnetic core, a diameter of the main body of the static magnetic core is larger than a diameter of the flange of the movable magnetic core to increase an electromagnetic attraction between the static magnetic core and the movable magnetic core.

10. The contactor electromagnetic assembly according to claim 9, wherein the movable magnetic core is movable between a working position in axial contact with the static magnetic core and an initial position in axial separation from the static magnetic core, and when the coil assembly is energized, the movable magnetic core is moved from the initial position to the working position under an action of electromagnetic force.

11. The contactor electromagnetic assembly according to claim 10, further comprising a reset spring axially compressed between the static magnetic core and the movable magnetic core, the reset spring applies an elastic reset force to the movable magnetic core, and when the coil assembly loses power, the movable magnetic core is moved from the working position to the initial position under an action of the reset spring.

12. The contactor electromagnetic assembly according to claim 11, wherein a limit step is formed in the coil skeleton, the limit step axially rests on the flange of the movable magnetic core to restrict the movable magnetic core in the initial position.

13. The contactor electromagnetic assembly according to claim 11, wherein a first central through-hole is formed in the static magnetic core, and a first positioning step is formed in the first central through-hole, a second central through-hole is formed in the movable magnetic core, and a second positioning step is formed in the second central through-hole, an upper end of the reset spring is accommodated in the first central through-hole and axially rests against the first positioning step, and a lower end of the reset spring is accommodated in the second central through-hole and axially rests against the second positioning step.

14. The contactor electromagnetic assembly according to claim 9, wherein a fixing hole is formed in the magnetic plate, a fixing portion of the static magnetic core is fixed to the fixing hole of the magnetic plate.

15. The contactor electromagnetic assembly according to claim 12, further comprising a magnetic sleeve inserted into a lower end of the coil skeleton, the movable magnetic core is arranged in the magnetic sleeve in a movable manner, so that the movable magnetic core can be moved axially relative to the magnetic sleeve.

16. The contactor electromagnetic assembly according to claim 15, wherein the magnetic yoke has a pair of side plates and a bottom plate located between the pair of side plates, a lower end of the magnetic sleeve is pressed against the bottom plate of the magnetic yoke, and an upper end of the magnetic sleeve is pressed against the limit step inside the coil skeleton, so that the magnetic sleeve cannot be moved axially.

17. The contactor electromagnetic assembly according to claim 10, further comprising a drive shaft that passes through the static magnetic core and the movable magnetic core in an axial direction, and is used to drive a movable contact of the contactor to move between an open position electrically separated from a static contact and a closed position electrically in contact with the static contact, a lower end of the drive shaft is welded to the movable magnetic core and can be moved axially relative to the static magnetic core.

18. The contactor electromagnetic assembly according to claim 17, wherein when the movable magnetic core is moved to the working position, the drive shaft drives the movable contact to the closed position, and when the movable magnetic core is moved to the initial position, the drive shaft drives the movable contact to the open position.

19. The contactor electromagnetic assembly according to claim 9, wherein the coil assembly further comprises a terminal module including:
a pair of coil terminals which are respectively connected to a pair of terminals of the coil assembly;
a pair of signal terminals electrically connected to a plurality of auxiliary contacts; and
a retaining body injection molded onto the pair of coil terminals and the pair of signal terminals, so that the retaining body, the pair of coil terminals, and the pair of signal terminals become an integrated piece, the coil skeleton is injection molded onto the terminal module, making the coil skeleton and the terminal module an integrated piece.

20. The contactor electromagnetic assembly according to claim 19, wherein the signal terminal has a mating end matable with an auxiliary contact adapter terminal, and a slot hole is formed on the magnetic plate, the mating end of the signal terminal is exposed from the slot hole of the magnetic plate for mating with the auxiliary contact adapter terminal.

21. The contactor electromagnetic assembly according to claim 19, wherein the coil skeleton has a mating portion, which has an insertion slot allowing a connector insertion, the coil terminals each have a first pin, and the signal terminals each have a second pin, the first pins and the second pins extend into the insertion slot of the mating portion to electrically connect with the connector inserted into the insertion slot.

22. A contactor, comprising:
a housing formed with an arc extinguishing chamber and a receiving chamber;
a pair of static contacts fixed to the housing and extending into the arc extinguishing chamber;
a movable contact set in the arc extinguishing chamber, the movable contact set is movable between an open position electrically separated from the pair of static contacts and a closed position electrically in contact with the pair of static contacts; and
a contactor electromagnetic assembly installed in the receiving chamber of the housing, the contactor electromagnetic assembly includes:
a magnetic yoke that is U-shaped;
a magnetic plate installed on a top opening of the magnetic yoke;
a coil assembly installed in the magnetic yoke and including a coil skeleton and a coil wound around the coil skeleton; and
a contactor magnetic core, including:
a static magnetic core fixed to the magnetic plate and having a main body inserted into the coil skeleton; and
a movable magnetic core inserted into the coil skeleton in a movable manner and having a flange at an upper end, when the static magnetic core and the movable magnetic core are inserted into the coil skeleton, the main body of the static magnetic core faces the flange of the movable magnetic core, a diameter of the main body of the static magnetic core is larger than a diameter of the flange of the movable magnetic core to increase an electromagnetic attraction between the static magnetic core and the movable magnetic core.
